(19) United States
(12) Patent Application Publication
(10) Pub. No.: US 2003/0074283 A1
(43) Pub. Date: Apr. 17, 2003

(54) Inventory management system for automatically integrating information related to future orders and delivery

(75) Inventors: Jen-Fu Lee, Taipei (TW); Li-Kuei Lin, Taipei (TW)

Correspondence Address: BACON & THOMAS, PLLC, 625 SLATERS LANE, FOURTH FLOOR, ALEXANDRIA, VA, 22314

(73) Assignee: Inventec Corporation, Taipei (TW)

(21) Appl. No.: 09/975,146

(22) Filed: Oct. 12, 2001

(51) Int. Cl. G06F 17/60

(52) U.S. Cl. 705/28

(57) ABSTRACT

The invention is an inventory management system for automatically integrating information related to future orders and delivery, which will automatically convert the specifications and quantity of the delivered products into specifications and quantity of the corresponding component parts through a conversion table after finishing a delivery of the products, and delete the specifications and the quantity of the corresponding component parts from the database, thereby automatically integrating information related to the future orders and the delivery.

### FIELD OF THE INVENTION

The present invention relates to inventory management system, and more particularly to such an inventory management system for automatically integrating information related to future orders and delivery.

### BACKGROUND OF THE INVENTION

Information technologies have known a rapid and a spectacular development in decades. And in turn competition has become even fierce in all fields. Also, an increasing use of telecommunications and the convenience of transportation have expanded global commerce and trade significantly. In view of this, almost all well known product manufacturers endeavor to research and analyze resources of manpower, capitals, technologies, and distribution in the world. Thereafter, it is possible of utilizing characteristics and advantages associated with various regions in the world for establishing branches of research and development, manufacturing, and trade therein. In one aspect, the research and development branch can tailor the needs of local market to design appropriate products. Further, the manufacturing branch may manufacture the same. Finally, the manufactured products may be delivered to the consumers through associated distributors in the world. This process can significantly reduce cost and delivery time as well as enhance competition. As stated above, almost all well known product manufacturers endeavor to integrate their design, development, manufacturing, and marketing in their global strategy. Further, the research and development branch is required to tailor the needs of local market to design appropriate products. Finally, the manufactured products may be quickly delivered to the consumers through associated distributors in the world. As to the product manufacturers, they have to increase information communication efficiency thereof so as to cooperate with associated manufacturers. Also, the communication should be efficient and accurate. With this, it is possible of truly reflecting markets, quickly delivering goods, and minimizing inventory. As a result, the purposes of attracting consumers with such products and being competitive in the markets are obtained.

In general, a mechanism for estimating future needs is established among buyers, products manufacturers, and component part suppliers (or manufacturer) under above manufacturing mode wherein a network connection is utilized to interconnect computer systems among buyers, product manufacturers and component part suppliers. This establishes a communication channel among them. Hence, product manufacturer may estimate quantity of component parts demanded by buyers (by estimation also) in a forthcoming period of time. And in turn, component part suppliers may be informed of the quantity of estimated component parts by product manufacturer. Hence, component part suppliers can estimate possible quantity of supplied component parts based on inventory and production thereof during the specified period of time. This can minimize inventory cost. Also, product manufacturer can take the estimated quantity of component parts as a basis for accepting orders from buyers. Eventually, after ordering buyer may be assured of obtaining the desired goods from product manufacturer after the specified period of time.

Conventionally, estimated quantity of component parts demanded by buyers in a forthcoming period of time are written into a document prior to informing product manufacturer. But the specifications of products vary rapidly in recent years. Hence, buyer may assign items of document as component parts of product. Such itemized document may be sent to product manufacturer through network connection for estimating demands in a forthcoming period of time. In the example of notebook computer, items listed in document may comprises specifications and quantity of central processing unit (CPU), hard disk drive, CD-ROM, sound card, display, and so on. As such, product manufacturer may store sufficient component parts for tailoring manufacturing needs. However, in fact buyer assigns items of document as model of product (e.g., model of notebook computer). Then product manufacturer manufactures products based on orders from buyer and specifications thereof. Finally, delivery department may deliver based on models of products after the product manufacturing. Hence, after finishing the transaction, product manufacturer cannot delete assembled component parts from inventory in database immediately. As a result there is an inconsistency (sometimes significant) between shown inventory and actual inventory in database with respect to component parts. In response, product manufacturer may usually require employees to check inventory of component parts manually. This is time and labor consuming. Further, a potential error in above manual checking may adversely affect the accuracy of inventory of component parts. This in turn brings a number of disadvantages such as insufficient component parts and thus delivery delay, or excessive component parts and thus inventory cost increase.

Thus, it is desirable to provide an improved inventory management system for automatically integrating information related to future orders and delivery in order to overcome the above drawbacks of prior art

### SUMMARY OF THE INVENTION

It is therefore an object of the present invention to provide an inventory management system including a database, a conversion table, and a network connection interconnected computer systems of various departments of a product manufacturer, a process comprising the steps of preparing component parts based on specifications and quantity of the component parts contained in estimated future orders received from a buyer; arranging manufacturing processes for producing products based on specifications and quantity of the component parts contained in actual orders continuously received from the buyer; after finishing a delivery of the products automatically converting specifications and quantity of the delivered products into specifications and quantity of the corresponding component parts through the conversion table; and deleting the specifications and the quantity of the corresponding component parts from the database, thereby automatically integrating information related to the future orders and the delivery. This can significantly simplify checking procedure and reduce checking time with respect to actual inventory of component parts. Also, a more precise estimation of future quantity of component parts is made possible by product manufacturer, thus maintaining inventory of component parts at an optimum.

The above and other objects, features and advantages of the present invention will become apparent from the following detailed description taken with the accompanying drawings.

### BRIEF DESCRIPTION OF THE DRAWINGS

FIG. 1 is a block diagram of a first preferred embodiment of inventory management system according to the invention;

FIG. 2 is a block diagram of a second preferred embodiment of inventory management system according to the invention; and

FIG. 3 is a block diagram showing an integration of either inventory management system according to the invention.

### DETAILED DESCRIPTION OF THE PREFERRED EMBODIMENTS

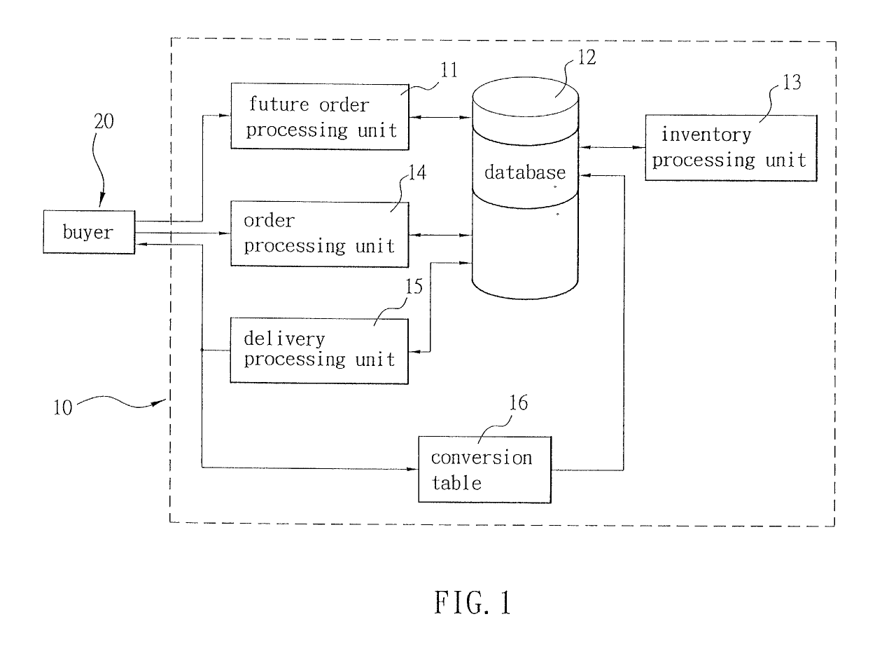

Referring to FIG. 1, there is shown a first embodiment of inventory management system 10 for automatically integrating information related to future orders and delivery in accordance with the invention. The system 10 utilizes a network connection for interconnecting computer systems of various departments of product manufacturer. System 10 comprises a future order processing unit 11 for receiving future orders from buyer (e.g., computer system of buyer) 20 through a network connection, a database 12 for storing information related to component parts (e.g., specifications and quantity of CPUs, hard disk drives, CD-ROMs, sound cards, displays, and so on) specified in the future orders, an inventory processing unit 13 for accessing information related to component parts specified in the future orders from database 12 for analysis so as to prepare the required specifications and quantity of the component parts contained in the future orders and enter inputs of actual inventory of component parts having required specifications and quantity into database 12, an order processing unit 14 for receiving actual orders from buyer 20 through network connection and storing product information (e.g., model and quantity of notebook computer) specified in the orders in database 12 and retrieving the same from database 12, a delivery processing unit 15 for sending product information related to products to be delivered to buyer 20 through network connection and deleting models and quantity of finished products from product information of the inventory in database 12, and a conversion table 16 having a comparison table for storing specifications of various products (e.g., models of notebook computers) and specifications of corresponding various component parts (e.g., specifications of CPUs, hard disk drives, CD-ROMs, sound cards, displays, and so on). Hence, product information listed on actual orders may be quickly converted into component part information through conversion table 16. Conversion table 16 has one end coupled to both delivery processing unit 15 and buyer 20. As such, as delivery processing unit 15 sends product information related to products to be delivered to buyer 20 product information related to actual orders may be automatically converted into specifications and quantity of corresponding component parts through conversion table 16. Then delete such specifications and quantity of component parts from actual inventory in database 12. This can significantly simplify checking procedure and reduce checking time with respect to actual inventory of component parts. Also, a more precise estimation of future quantity of component parts is made possible by product manufacturer, thus maintaining inventory of component parts at an optimum.

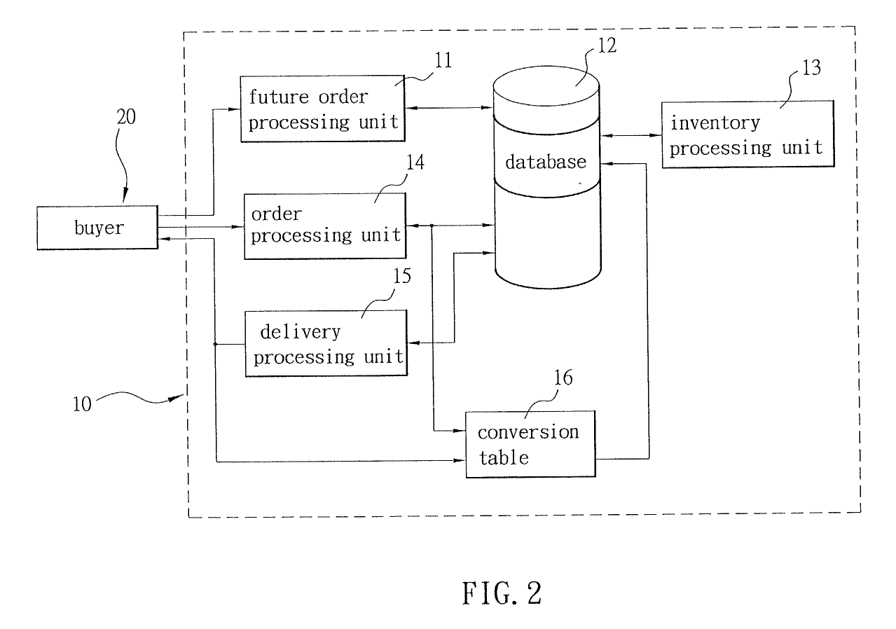

Referring to FIG. 2, there is shown a second preferred embodiment of inventory management system according to the invention. Order processing unit 14 can receive actual orders from buyer 20 through network connection and store product information (e.g., model and quantity of notebook computer) specified in the orders in database 12. Alternatively, order processing unit 14 can convert products listed on the orders into component part information through conversion table 16 prior to storing the same in database 12. Hence, component part department may regularly check a difference (if any) between component parts having required specifications and quantity as specified in orders and actual inventory of component parts. The result may be used as a basis for component part procurement.

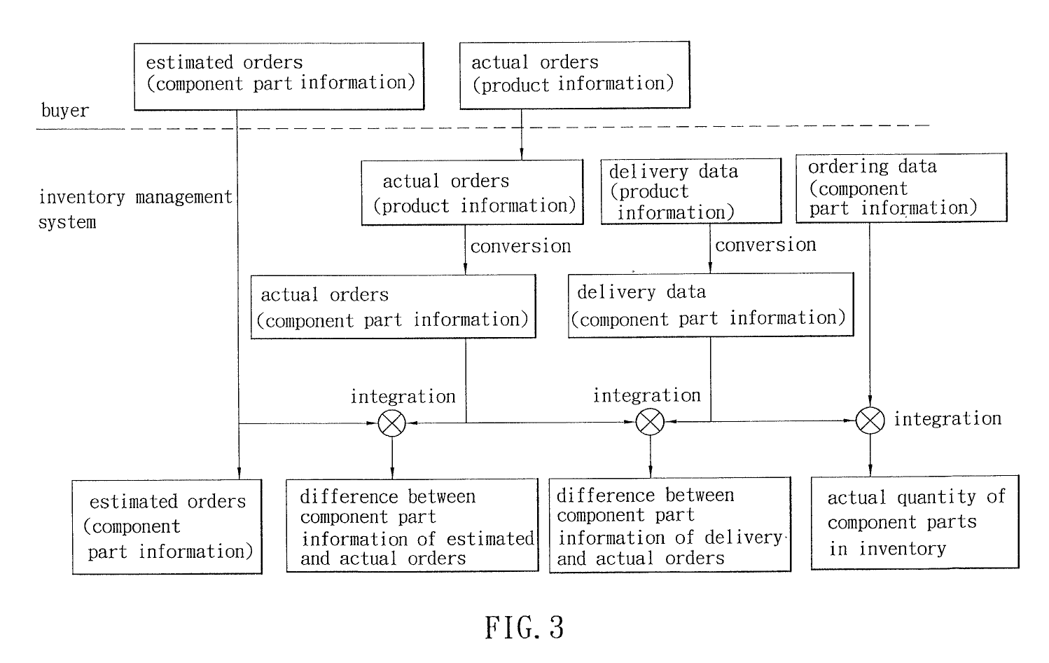

FIG. 3 is a block diagram showing an integration of either inventory management system according to the invention. As shown, product information (e.g., models and quantity of notebook computers) contained in actual orders sent from buyer is automatically converted into component part information through conversion table 16 of inventory management system 10. Hence, component part information in actual orders may be easily integrated with corresponding component part information of estimated future orders previously received in inventory management system 10. Such integrated information is stored in database 12 as a reference for evaluating a difference (if any) between component part information of estimated future orders and actual orders. Further, as stated above as delivery department of product manufacturer finishes delivery information related to the delivered products, which is automatically converted into specifications and quantity of corresponding component parts through conversion table 16. Hence, component part information corresponding to delivered products may integrate with component part information of actual orders and actual inventory respectively prior to storing in database 12. This can be used as a basis for checking or procuring component parts by the employees of component part department.

In brief, component part department of product manufacturer may prepare component parts based on component part information contained in future orders from buyer 20 by utilizing inventory management system 10. Further, manufacturing department may arrange manufacturing processes based on specifications and quantity of actual orders continuously received from business department. Moreover, as delivery department finishes delivery specifications and quantity of the delivered products, which are automatically converted into specifications and quantity of corresponding component parts through conversion table 16. In addition, component parts used for manufacturing the products are deleted from database 12. This can significantly simplify checking procedure and reduce checking time with respect to actual inventory of component parts. Also, a more precise estimation of future used quantity of component parts is made possible by product manufacturer, thus reducing the cost by eliminating the storage of excessive component parts in the inventory.

While the invention has been described by means of specific embodiments, numerous modifications and variations could be made thereto by those skilled in the art without departing from the scope and spirit of the invention set forth in the claims.

What is claimed is:

1. In an inventory management system including a database, a conversion table, and a network connection interconnected computer systems of various departments of a product manufacturer, a process comprising the steps of:
preparing component parts based on specifications and quantity of the component parts contained in estimated future orders received from a buyer;
arranging manufacturing processes for producing products based on specifications and quantity of the component parts contained in actual orders continuously received from the buyer;
after finishing a delivery of the products automatically converting specifications and quantity of the delivered products into specifications and quantity of the corresponding component parts through the conversion table; and
deleting the specifications and the quantity of the corresponding component parts from the database, thereby automatically integrating information related to the future orders and the delivery.

2. The process of claim 1, wherein the conversion table has a comparison table being operative to store the specifications of the various products and the specifications of the corresponding various component parts so as to convert a product information into component part information through the conversion table.

3. The process of claim 2, wherein the system further comprises:
a future order processing unit for receiving the future orders from the buyer through the network connection and storing information related to the component parts contained in the future orders;
an inventory processing unit for accessing information related to the component parts contained in the future orders from the database for analysis so as to prepare the required specifications and quantity of the component parts contained in the future orders and enter inputs of an actual inventory of the component parts having the required specifications and quantity into the database;
an order processing unit for receiving the actual orders from the buyer through the network connection, storing product information contained in the actual orders in the database, and retrieving the same from the database; and
a delivery processing unit for sending product information related to products to be delivered to the buyer through the network connection and deleting product information related to the products to be delivered from product information of an inventory in the database.

4. The process of claim 3, wherein the conversion table has one end coupled to both the delivery processing unit and the buyer so that as the delivery processing unit sends product information related to the products to be delivered to the buyer product information related to the actual orders, the product information related to the products being delivered is automatically converted into the specifications and the quantity of the corresponding component parts through the conversion table and delete the specifications and the quantity of the corresponding component parts from the actual inventory in the database.

5. The process of claim 3, wherein the order processing unit is operative to receive the actual orders from the buyer through the network connection and either store product information contained in the actual orders in the database or convert product information contained in the actual orders into component part information through the conversion table prior to storing the same in the database.
